(19) United States
(12) Patent Application Publication
(10) Pub. No.: US 2013/0009097 A1
(43) Pub. Date: Jan. 10, 2013

(54) OXYNITRIDE PHOSPHOR AND METHOD OF MANUFACTURING THE SAME

(75) Inventors: CHENG-I CHU, TAIPEI CITY (TW); RU-SHI LIU, TAIPEI CITY (TW); YU-CHIH LIN, TAOYUAN (TW); CHEN-HONG LEE, TAOYUAN (TW); WEI-KANG CHENG, TAOYUAN (TW); YI-SHENG TING, TAOYUAN (TW); SHYI-MING PAN, TAOYUAN (TW)

(73) Assignee: FORMOSA EPITAXY INCORPORATION, Taoyuan County (TW)

(21) Appl. No.: 13/541,969

(22) Filed: Jul. 5, 2012

(30) Foreign Application Priority Data
Jul. 5, 2011 (TW) 100123637

(51) Int. Cl. C09K 11/79

(52) U.S. Cl. 252/301.4 R

(57) ABSTRACT

An oxynitride phosphor and a method of manufacturing the same are revealed. The formula of the oxynitride phosphor is Ba₃₋ₓSi₆O₁₂N₂: Yₓ (0≦x≦1). Y is praseodymium (Pr) or terbium (Tb) used as a luminescent center. The oxynitride phosphor is synthesized by solid-state reaction. The oxynitride phosphor is excited by vacuum ultraviolet light with a wavelength range of 130 nm to 300 nm or ultraviolet to visible light with a wavelength range of 300 nm to 550 nm to emit light with a wavelength range of 400 nm to 700 nm. Moreover, the full-width at half-maximum of the emission spectrum is smaller than 30 nm. Thus the oxynitride phosphor is suitable for applications of backlights, plasma display panels and ultraviolet excitation. The oxynitride phosphor has higher application value.

### BACKGROUND OF THE INVENTION

1. Fields of the Invention

The present invention relates to a phosphor and a method of manufacturing the same, especially to an oxynitride phosphor and a method of manufacturing the same.

2. Descriptions of Related Art

For energy savings, carbon reduction, and environment protection, conventional light sources are gradually replaced by white-light LED (light emitting diode)-based lighting in developed countries. The LED features on compact size, low power consumption, long life time, low heat emission, and short reaction time. LED is easy to install in equipment, of low heat radiation, and used for high frequency operation and over 100 thousand hours. It uses only one-eighths or one-tenths power in comparison with conventional light bulbs and a half power compared with fluorescent lights. LED overcomes a plurality of shortcomings of incandescent bulbs. Thus the white light LED is a new light source for illumination and displays of the 21st century. It is called green light source due to its features of energy saving and environment protection.

Refer to U.S. Pat. No. 5,998,925 applied by Japanese Nichia Corporation filed in 1996, a light emitting diode (LED) includes a semiconductor element emitting blue light and a phosphor activated with cerium. The phosphor is Cerium-doped yttrium aluminum garnet (YAG:Ce) that emits yellow light. Thus the LED emits white light by blending the blue light and the yellow light emitted by the phosphor. Although the nitride phosphors available now are of better thermal resistance and water resistance, its cost is high. The cost of oxide phosphors is low yet it has poor thermal stability and poor water resistance. Thus oxynitride phosphors have received considerable attention compared to the existing nitride and oxide phosphors. The precursor for synthesis of the oxynitride phosphors does not include nitride with extreme air-sensitivity. The synthesis temperature is reduced by using a part of oxides. Moreover, the oxynitride phosphors have good stability similar to that of the nitrides. The oxynitride phosphors have advantages of both oxides and nitrides. Thus a plurality of oxynitride phosphors including β-SiAlON, MSi₂O₂N₂ (M=Ca, Sr, Ba), etc. has been developed recently.

As to the oxynitride phosphor MₓA_{y}B_{z}OᵤNᵥ (0.00001≦y≦3; 0.00001≦z≦6; 0.00001≦u≦12; 0.00001≦v≦12; 0.00001≦x≦5), M is a single active center or a mixture of active centers. A is a bivalent element or a mixture of a plurality of bivalent elements. B can be a trivalent element, a tetravalent element, a mixture of a plurality of trivalent elements or a mixture of a plurality of tetravalent elements. O is a univalent element, a bivalent element, a mixture of a plurality of univalent elements, or a mixture of a plurality of bivalent elements. N is a univalent element, a bivalent element, a trivalent element, a mixture of a plurality of univalent elements, a mixture of a plurality of bivalent elements, or a mixture of a plurality of trivalent elements. This chemical formula has been developed and patented by OSRAM GESELLSCHAFT MIT BESCHRÄNKTER HAFTUNG in 2008 with Pat. App. No. PCT/EP2008/059726 and the title is “TEMPERATURE-STABLE OXYNITRIDE PHOSPHOR AND LIGHT SOURCE COMPRISING A CORRESPONDING PHOSPHOR MATERIAL”. However, the patent doesn't disclose that this formula is able to be synthesized under high pressure.

In 2009, Mitsubishi Chemical Corporation has also applied for the patent with Pub. No. WO/2009/017206, App. No. PCT/JP2008/063802 filed on Jul. 31, 2008 and the title is “PHOSPHOR AND METHOD FOR PRODUCING THE SAME, CRYSTALLINE SILICON NITRIDE AND METHOD FOR PRODUCING THE SAME, PHOSPHOR-CONTAINING COMPOSITION, LIGHT-EMITTING DEVICE USING THE PHOSPHOR, IMAGE DISPLAY DEVICE, AND ILLUMINATING DEVICE”. A pure product revealed in this patent is synthesized under normal pressure and is obtained by using pre-treated silicon nitride (Si₃N₄) precursor.

In recent years, light emitting devices with phosphor composition have been applied to backlights. The full width at half maximum (FWHM) of the phosphor required is smaller than 30 nm so that the resolution of the spectrum is improved after passing through a filter. The patents mentioned above don't disclose formula of phosphors whose FWHM is smaller than 30 nm.

### SUMMARY OF THE INVENTION

Therefore it is a primary object of the present invention to provide an oxynitride phosphor and a method of manufacturing the same. The full width at half maximum (FWHM) of a peak of emission wavelength of the oxynitride phosphor is smaller than 30 nm so that the oxynitride phosphor is applied to backlights.

It is another object of the present invention to provide an oxynitride phosphor and a method of manufacturing the same. The oxynitride phosphor is excited by vacuum ultraviolet light with a wavelength range of 130 nm to 300 nm or light with a wavelength range of 300 nm to 550 nm wavelength range. The emission wavelength of the oxynitride phosphor is ranging from 400 nm to 700 nm. Thus the oxynitride phosphor can be applied to plasma display panels.

It is a further object of the present invention to provide an oxynitride phosphor and a method of manufacturing the same. A precursor is sintered under high pressure and high temperature for synthesis of the oxynitride phosphor. The manufacturing process is simple and the phosphor can be mass-produced.

In order to achieve the above objects, an oxynitride phosphor of the present invention is provided. The general formula of the oxynitride phosphor is Ba₃₋ₓSi₆O₁₂N₂: Yₓ, wherein x is ranging from 0 to 1 and Y is praseodymium (Pr) or terbium (Tb) used as a luminescent center. The full width at half maximum (FWHM) of a peak of emission wavelength of the oxynitride phosphor is smaller than 30 nm.

A method of manufacturing an oxynitride phosphor of the present invention is provided. And the method includes a plurality of steps. Firstly, provide a precursor and then sinter the precursor by solid-state reaction for synthesis of an oxynitride phosphor. The general formula of the oxynitride phosphor is Ba₃₋ₓSi₆O₁₂N₂: Yₓ, wherein x is ranging from 0 to 1 and Y is praseodymium (Pr) or terbium (Tb) used as a luminescent center. The full width at half maximum (FWHM) of the oxynitride phosphor is smaller than 30 nm.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of an embodiment according to the present invention;

FIG. 2 is a list showing a molar ratio of components of a precursor of another embodiment according to the present invention;

FIG. 3 shows X-ray powder diffraction patterns of an embodiment according to the present invention;

FIG. 4 shows excitation spectra of Ba_{2.89}Si₆O₁₂N₂:Tb_{0.11} of an embodiment excited by vacuum ultraviolet light according to the present invention;

FIG. 5 shows another kind of excitation spectra of Ba_{2.89}Si₆O₁₂N₂:Tb_{0.11} of an embodiment excited by vacuum ultraviolet light according to the present invention;

FIG. 6 is an emission spectrum of Ba_{2.89}Si₆O₂N₂:Tb_{0.11} of an embodiment excited by ultraviolet light according to the present invention;

FIG. 7 is an excitation spectrum of Ba_{2.89}Si₆O₁₂N₂:Tb_{0.11} of an embodiment excited by ultraviolet light according to the present invention;

FIG. 8 is an emission spectrum of Ba_{2.89}Si₆O₁₂N₂:Pr_{0.11} of an embodiment excited by ultraviolet light according to the present invention;

FIG. 9 is an excitation spectrum of Ba_{2.89}Si₆O₁₂N₂:Pr_{0.11} of an embodiment excited by ultraviolet light according to the present invention.

### DETAILED DESCRIPTION OF THE PREFERRED EMBODIMENT

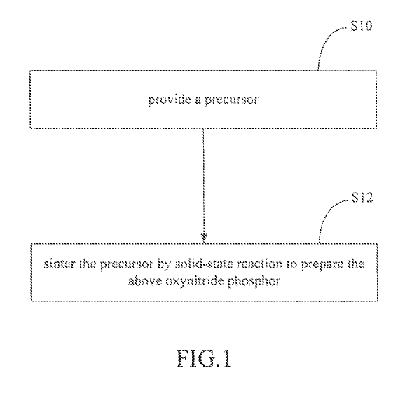

Refer to FIG. 1, the present invention provides an oxynitride phosphor whose general formula is Ba₃₋ₓSi₆O₁₂N₂: Yₓ, wherein x is ranging from 0 to 1 and Y is praseodymium (Pr) or terbium (Tb) used as a luminescent center. A method of manufacturing the oxynitride phosphor of the present invention includes following steps. Firstly, take the step S10, provide a precursor. Then run the step S12, sinter the precursor by solid-state reaction to prepare the above oxynitride phosphor. The precursor includes at least one of elements selected from barium carbonate, silicon dioxide, silicon nitride, and praseodymium oxide. Or the precursor includes at least one of elements selected from barium carbonate, silicon dioxide, silicon nitride, and terbium oxide. The sintering pressure is ranging from 0.1 MPa to 1000 MPa and the sintering temperature is ranging from 1200 degrees Celsius to 1800 degrees Celsius.

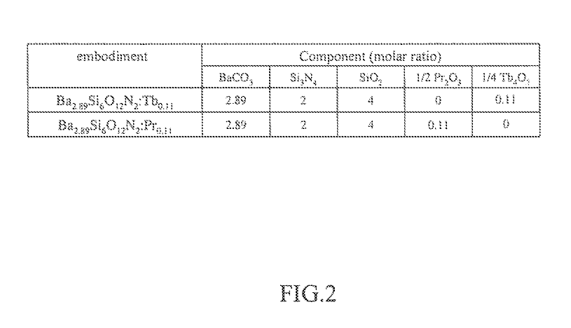

Refer to FIG. 2, a molar ratio of components of a precursor of an embodiment according to the present invention is listed. As show in the figure, this embodiment relates to manufacturing of Ba_{2.89}Si₆O₁₂N₂:Tb_{0.11} and Ba_{2.89}Si₆O₁₂N₂:Pr_{0.11}. The precursor of Ba_{2.89}Si₆O₁₂N₂:Tb_{0.11} includes barium carbonate (BaCO₃), silicon nitride (Si₃N₄), silicon dioxide (SiO₂), and terbium oxide (Tb₄O₇). BaCO₃:Si₃N₄:SiO₂:1/4Tb₄O₇=2.89:2:4:0.11. The precursor is ground and mixed evenly in a mortar. Then the precursor is sintered under nitrogen pressure of 0.92 MPa at 1375 degrees Celsius for 1 hour to get Ba_{2.89}Si₆O₁₂N₂:Tb_{0.11}. The Ba_{2.89}Si₆O₁₂N₂:Pr_{0.11} is produced in a similar way. The precursor of Ba_{2.89}Si₆O₁₂N₂:Pr_{0.11} consists of barium carbonate (BaCO₃), silicon nitride (Si₃N₄), silicon dioxide (SiO₂), and praseodymium oxide (Pr₂O₃), BaCO₃:Si₃N₄:SiO₂:1/2Pr₂O₃=2.89:2:4:0.11. Then the precursor is sintered under the same conditions to get Ba_{2.89}Si₆O₁₂N₂:Pr_{0.11}. The manufacturing process mentioned above is simple and the oxynitride phosphor can be mass-produced.

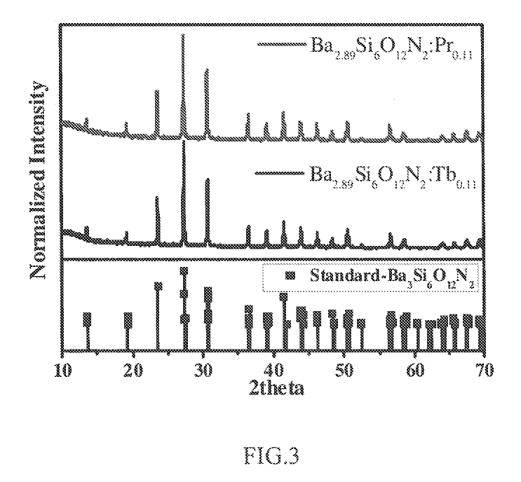

Refer to FIG. 3, an embodiment of the present invention is characterized by X ray powder diffraction (XRD). As shown in the figure, Ba_{2.89}Si₆O₁₂N₂:Tb_{0.11} and Ba_{2.89}Si₆O₁₂N₂:Pr_{0.11} synthesized by the solid-state reaction method are examined by X ray powder diffraction to access phase purity. It is learned from the figure that the oxynitride phosphor synthesized is pure.

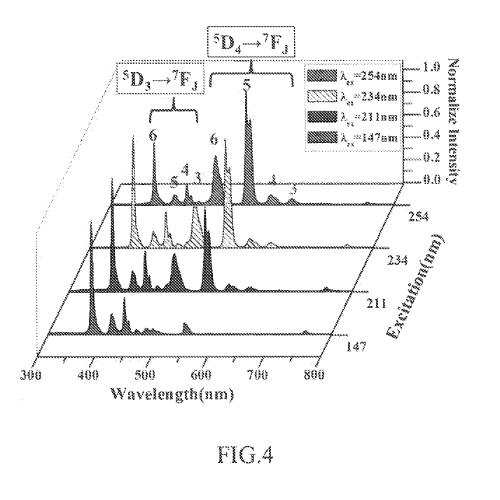

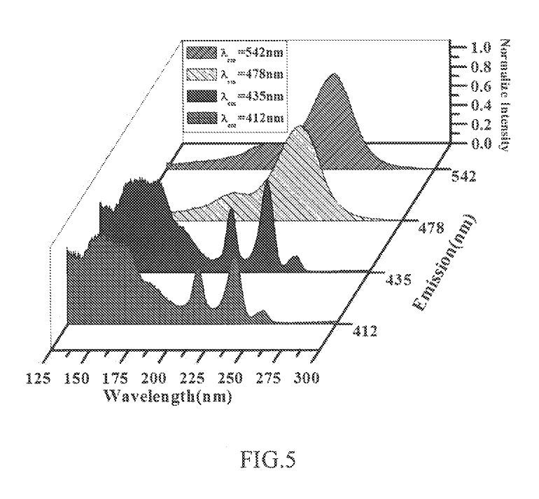

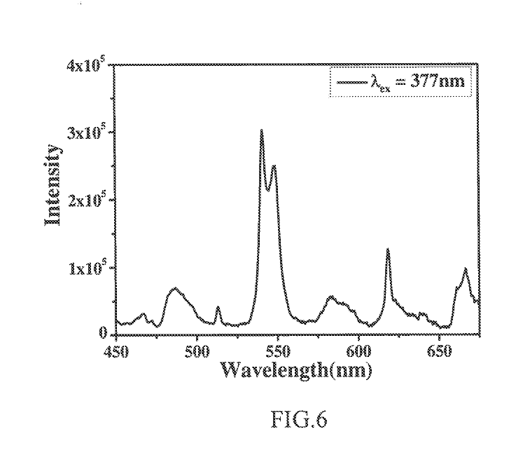

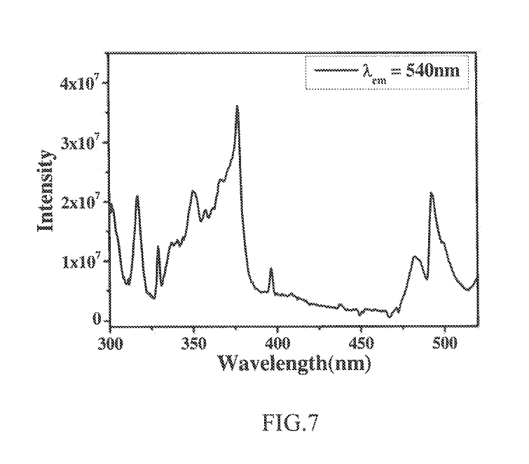

Refer to FIG. 4, FIG. 5, FIG. 6 and FIG. 7, excitation spectra and emission spectra of Ba_{2.89}Si₆O₁₂N₂:Tb_{0.11} are revealed. As shown in the figures, the Ba_{2.89}Si₆O₁₂N₂:Tb_{0.11} prepared is excited by vacuum ultraviolet or ultraviolet light with a wavelength range of 130 nm to 300 nm to emit green luminescence with a peak wavelength of 540 nm. Thus the oxynitride phosphor Ba_{2.89}Si₆O₁₂N₂:Tb_{0.11} of the present invention is applied to devices with UV excitation sources such as plasma display panels. Moreover, the full width at half maximum (FWHM) of a peak of emission wavelength of Ba_{2.89}Si₆O₁₂N₂:Tb_{0.11} is smaller than 30 nm. Thus it is suitable for backlight applications.

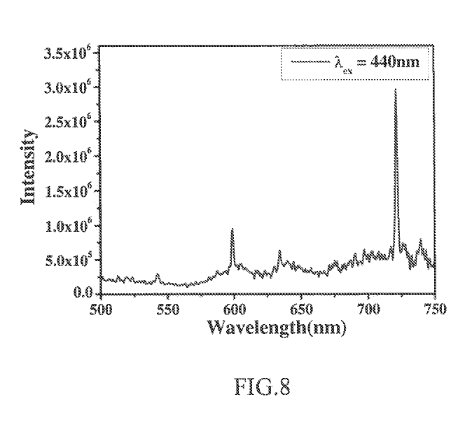

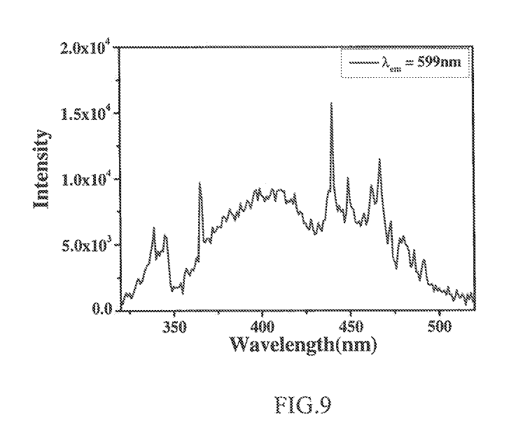

Refer to FIG. 8 and FIG. 9, an emission spectra and an excitation spectra of Ba_{2.89}Si₆O₁₂N₂:Pr_{0.11} are disclosed. As shown in the figure, the Ba_{2.89}Si₆O₁₂N₂:Pr_{0.11} prepared is excited by vacuum ultraviolet light or ultraviolet to visible light with a wavelength range of 300 nm to 550 nm to emit red luminescence with a peak wavelength of 599 nm. Thus the oxynitride phosphor Ba_{2.89}Si₆O₁₂N₂:Pr_{0.11} of the present invention is ideal for applications of UV excitation sources and blue light emitting diode. Moreover, the full width at half maximum (FWHM) of a peak of emission wavelength of Ba_{2.89}Si₆O₁₂N₂:Pr_{0.11} is smaller than 30 nm so that it is suitable for backlight applications.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An oxynitride phosphor having a formula Ba_{2.89}Si₆O₁₂N₂: Yₓ, wherein x is ranging from 0 to 1;
wherein Y is praseodymium (Pr) or terbium (Tb) used as a luminescent center; and
wherein full-width at half-maximum of a peak of emission wavelength of the oxynitride phosphor is smaller than 30 nm.

2. The oxynitride phosphor as claimed in claim 1, wherein the oxynitride phosphor is excited by light with a wavelength range of 300 nm to 550 nm or 130 nm to 300 nm.

3. A method of manufacturing an oxynitride phosphor as claimed in claim 1 comprising the steps of:
providing a precursor; and
sintering the precursor by solid-state reaction for synthesis of an oxynitride phosphor.

4. The method as claimed in claim 3, wherein the precursor includes at least one of elements selected from barium carbonate, silicon dioxide, silicon nitride, and praseodymium oxide.

5. The method as claimed in claim 3, wherein the precursor includes at least one of elements selected from barium carbonate, silicon dioxide, silicon nitride, and terbium oxide.

6. The method as claimed in claim 3, wherein a sintering temperature is ranging from 1200 degrees Celsius to 1800 degrees Celsius

7. The method as claimed in claim 3, wherein sintering pressure is ranging from 0.1 MPa to 1000 MPa.
